(19) United States
(12) Patent Application Publication
(10) Pub. No.: US 2014/0308169 A1
(43) Pub. Date: Oct. 16, 2014

(54) SYSTEM AND METHOD FOR A MICROLABORATORY

(71) Applicant: ALEKS FRANZ, MEDFORD, MA (US)

(72) Inventor: ALEKS FRANZ, MEDFORD, MA (US)

(73) Assignee: Chemicro LLC, MEDFORD, MA (US)

(21) Appl. No.: 14/251,574

(22) Filed: Apr. 12, 2014

Related U.S. Application Data
(60) Provisional application No. 61/811,703, filed on Apr. 13, 2013.

(51) Int. Cl. G01N 35/00

(52) U.S. Cl. CPC G01N 35/00
USPC 422/82.01; 422/68.1; 422/82.05; 73/865.8

(57) ABSTRACT

A micro-laboratory system for performing chemical, mechanical and electrical experiments includes a set of experiment chips and a test system. Each experiment chip includes chemical, mechanical, or electrical experiments and the test system is configured to receive the experiment chips and to perform the chemical, mechanical, or electrical experiments comprised in the experiment chips. The system also includes fluidic and electrical interfaces connecting the experiment chips and the test system. A computing unit connects and communicates with the test system, and runs applications that provide instructions for selecting, designing and performing experiments, analyzing experimental results and explaining relevant principles of the experiments.

### CROSS REFERENCE TO RELATED CO-PENDING APPLICATIONS

This application claims the benefit of U.S. provisional application Ser. No. 61811703 filed on Apr. 13, 2013 and entitled SYSTEM AND METHOD FOR A MICROLABORATORY, which is commonly assigned and the contents of which are expressly incorporated herein by reference.

### Field Of The Invention

The present invention relates to a system and method for a micro-laboratory (MicroLab) and in particular to a multi-disciplinary micro-laboratory based on on-chip experiments.

### BACKGROUND OF THE INVENTION

Currently, engineering education includes both classroom lectures and experimental laboratories. These activities are usually separate from each other, although integration of experimental activities in the lectures is desirable for pedagogic reasons. One of the reasons for not integrating laboratory experiments in the classroom lectures is usually the lack of large number of experimental laboratory sets. The cost of the various experimental laboratory sets and the lack of space prevent the full integration of experimental laboratory activities in the classroom.

Accordingly, there is a critical need in engineering education of more directly integrating experiments into engineering classrooms and curricula by using a low cost, space saving experimental laboratory set.

### SUMMARY OF THE INVENTION

The present invention describes a multi-disciplinary micro-laboratory (MicroLab) based on Micro Electro Mechanical Systems (MEMS) on-chip experiments.

In general, in one aspect, the invention features a micro-laboratory system for performing chemical, mechanical and electrical experiments. The system includes a set of experiment chips and a test system. Each experiment chip includes chemical, mechanical, or electrical experiments and the test system is configured to receive the experiment chips and to perform the chemical, mechanical, or electrical experiments comprised in the experiment chips. The system also includes fluidic and electrical interfaces connecting the experiment chips and the test system. A computing unit connects and communicates with the test system.

Implementations of this aspect of the invention may include one or more of the following features. The experiment chips are Micro-Electro-Mechanical-Systems (MEMS) experiment chips that are micro-fabricated on substrates made of of silicon, plastic, glass or ceramic materials. The experiment chips include sensors and actuators. The sensors may be thin film resistive temperature sensors, piezoelectric stress sensors, thermocouple temperature sensors, capacitive sensors, or pressure sensors. The actuators may be thin film resistive heaters, electrodes for electrostatic actuation, or electrodes for electrophoretic flow. The test system includes a test fixture and a test console and the test fixture is configured to receive the experiment chips and is connected to the test console via the fluidic and electrical interfaces. The micro-laboratory further includes applications configured to run on the computing unit and to provide instructions for selecting, designing and performing experiments, analyzing experimental results and explaining relevant principles of the experiments. The experiment chips include materials to be used in the experiments, and the materials may be catalytic materials to be used in carrying out chemical reactions, chemically active coatings for adsorption or separation experiments, or materials that will undergo phase change upon changing temperature. One of the experiment chips may be a catalytic micro-reactor experiment chip that is configured to perform experiments including heat transport, fluid flow, reaction thermodynamics, catalytic reactions or reactor design experiments. The catalytic micro-reactor experiment chip includes a thin membrane suspended above a channel and the thin membrane includes thin film metal heaters and temperature sensors placed on an outside of the channel surface and a catalytic thin film placed on an inside of the channel surface. Reactive gases are configured to flow through the channel, the temperature of the membrane and the catalytic thin film is configured to be changed and monitored by using the thin film metal heaters and the temperature sensors, respectively, and the composition of exiting gasses is configured to be analyzed using analytical tools comprised within the test console. One of the experiment chips may be a stress/strain beams and cantilevers experiment chip that is configured to perform experiments including beams and cantilevers, stress/force balances, or coefficient of thermal expansion. The stress/strain beams and cantilevers experiment chip includes two-layer beams and cantilevers. Each two-layer beam and cantilever includes two layers of thin films being superimposed on each other and suspended from a silicon frame, and the two layers of thin films have different coefficients of thermal expansion. The two-layer beams and cantilevers include a layer of silicon nitride and a layer of platinum metal. One of the two layers of thin films may be a patterned metal layer configured to function as a resistive heater. Applying voltage to the patterned metal layer heats the two-layer beams and cantilevers and causes the two layers of thin films to expand at different rates and to move relative to each other. One of the experiment chips is a fluidic experiment chip that includes a clear plastic chip having a channel formed therein. The micro-laboratory system further includes a pump and a pressure gauge, and the pump is configured to pump a liquid through the channel at selected flow rates and the pressure gauge is configured to measure pressure drop across the channel. The channel has straight tube-shaped geometry, s-tube-shaped geometry, or multi-tube-shaped geometry. The experiment chips are mounted onto a carrier substrate and the carrier substrate with the mounted experiment chips are configured to be inserted into the test fixture. An additional layer is inserted between the carrier substrate and the test fixture, and the additional layer includes openings and channels configured to complete fluidic routing, while providing fluidic sealing between the carrier substrate and the test fixture. The carrier substrate includes openings and channels configured to provide fluidic connections. The carrier substrate further includes conductive metallic lines configured to provide electrical connections between the substrate mounted experiment chips and the test console. The test fixture includes a bottom portion and a top portion and the bottom portion includes fluidic connections and the top portion includes electrical connections between the experiment chips and the test console. The carrier substrate with the mounted experiment chips is configured to be compressed between the top and bottom portions of the test fixture. The micro-laboratory system further includes a visualization tool. The visualization tool may be a Charged-Coupled Device (CCD) camera and microscope configured to be attached to the test fixture. The test console includes hardware components and electronic components used for performing the chemical, mechanical, or electrical experiments comprised in the experiment chips. The hardware components may be mass flow controllers for gases, pressure regulators, reservoirs, valves for liquid pumping, pressure driven liquid pumps, or pressure sensors. The electronic components may be electronic components for signal conditioning, supplying power, and controlling the hardware components and the experiment chips, or a data acquisition card. The experiment chips may be 3-D printed chips.

Among the advantages of this invention may be one or more of the following. The MicroLab product is designed to address the critical need in engineering education of more directly integrating experiments into engineering classrooms and curricula by using a low cost and space saving laboratory set. MEMS technology can be effectively used to demonstrate most of the diverse physical phenomena as well as more complex design and analysis principles that engineering students must understand and apply across multiple engineering disciplines. Unlike conventional technology, the MicroLab product offers a low cost, exciting, versatile and intrinsically safe platform for rapidly performing a wide variety of highly informative experiments.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1A is a schematic diagram of a MEMS-based MicroLab system according to this invention;

FIG. 1B is a picture of one example of a MEMS-based MicroLab system;

FIG. 2 is a schematic diagram of a catalytic reactor experiment chip;

FIG. 3 is a schematic diagram of a beams and cantilevers experiment chip;

FIG. 4 is a schematic diagram of a fluidic experiment chip;

FIG. 4A is a schematic diagram of a plastic chip with various fluid channel shapes;

FIG. 5 is a schematic diagram of experiment chip packaging;

FIG. 6 is a schematic diagram of fluidic routing options for connecting fluidic ports on an experiment chip ;

FIG. 6A depicts images of circuit boards that are used as substrates for supporting the experiment chips;

FIG. 7A is a schematic diagram of a test fixture;

FIG. 7B depicts an image of a test fixture;

FIG. 8 is a schematic diagram of a MicroLab console; and

FIG. 9 depicts images of the electric and fluidic connections in the console.

### DETAILED DESCRIPTION OF THE INVENTION

The present invention describes a multi-disciplinary micro-laboratory (MicroLab) based on Micro Electro Mechanical Systems (MEMS) on-chip experiments.

MicroLab can be thought of as an experiment “play station” for engineering students. MicroLab includes a set of packaged MEMS experiment ‘chips’, where the experiment chips serve as “game cartridges”. MicroLab also includes a versatile test station, analogous to the game console, that provides all of the hardware and electronics required to perform chemical, mechanical and electrical experiments. The exact type of experiment performed is determined by what type of a MEMS chip is placed inside the test station. Finally, MicroLab includes software that serves as an operating system for the test station, provides designed experiments and analytical assistance, as well as integrates explanation of relevant principles.

Microlab enables students and faculty to rapidly perform a large variety of experiments on microscopic, on-chip experiments. MicroLab is designed to perform a wide variety of experiments utilizing the same set of hardware and electronics. What type of an experiment is to be performed is determined by the type of experiment chip or “cartridge” that gets plugged into the test fixture. The test fixture serves as the fluidic and electrical interface between the experiment chip and the console, containing the hardware and electronics.

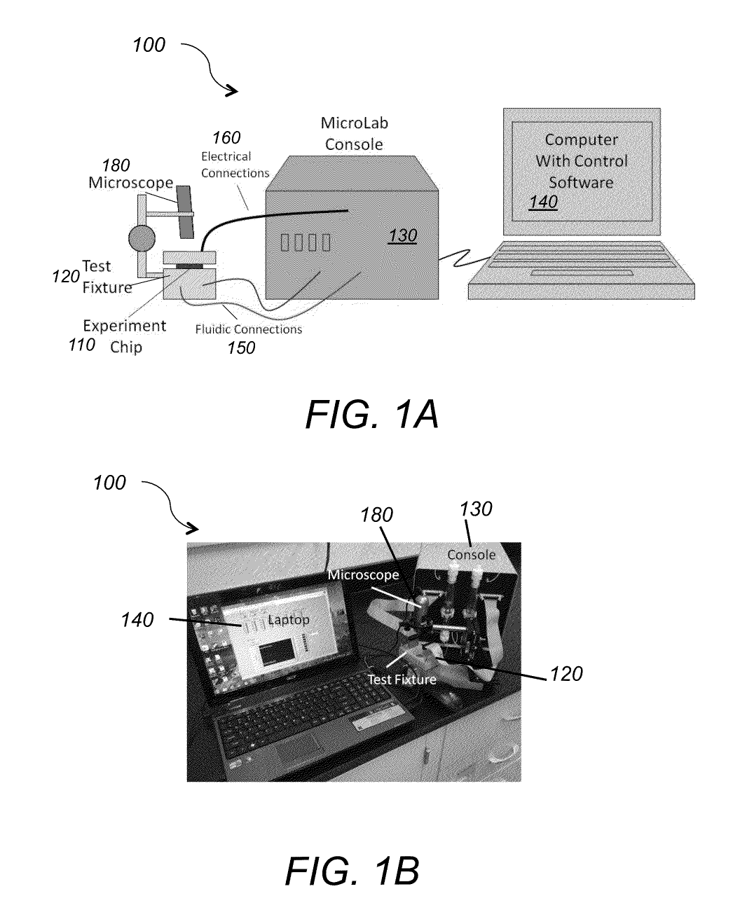

Referring to FIG. 1A and FIG. 1B, a micro-laboratory system 100 for performing chemical, mechanical and electrical experiments includes a Micro-Electro-Mechanical-Systems (MEMS) experiment chip 110, a test fixture 120, and a test console 130. Each MEMS experiment chip 110 includes chemical, mechanical, or electrical experiments. The test fixture 120 is configured to receive the MEMS experiment chips and to perform the chemical, mechanical, or electrical experiments. The system also includes fluidic 150 and electrical 160 interfaces connecting the test fixture 120 and the test console 150. A computer 140 connects and communicates with the test console 130 and runs applications that provide instructions for selecting, designing and performing experiments, analyzing experimental results and explaining relevant principles of the experiments. The system 100 also includes a microscope 180 for visualizing the experiments. In other examples the experiment chips are 3-D printed chips.

In one example the experiment chip 110 is microfabricated from silicon. In other examples, the chips are manufactured out of plastic, glass, or ceramic substrates using microfabrication techniques known in the field such as photolithography, stamping, and molding, among others. In some embodiments, the experiment chips have integrated sensors and actuators. Examples of actuators include but are not limited to thin film resistive heaters, electrodes for electrostatic actuation, and electrodes for electrophoretic flow, among others. Examples of sensors include but are not limited to thin film resistive temperature sensors, piezoelectric stress sensors, thermocouple temperature sensors, capacitive sensors, and pressure sensors, among others. The chips include various materials to be used in the experiments, including but not limited to catalytic materials to be used in carrying out chemical reactions, chemically active coatings for adsorption or separation experiments, materials that will undergo phase change upon changing temperature, among others. Multiple variants of the same experiment can be embedded within each chip, with the variants designed to teach a particular lesson.

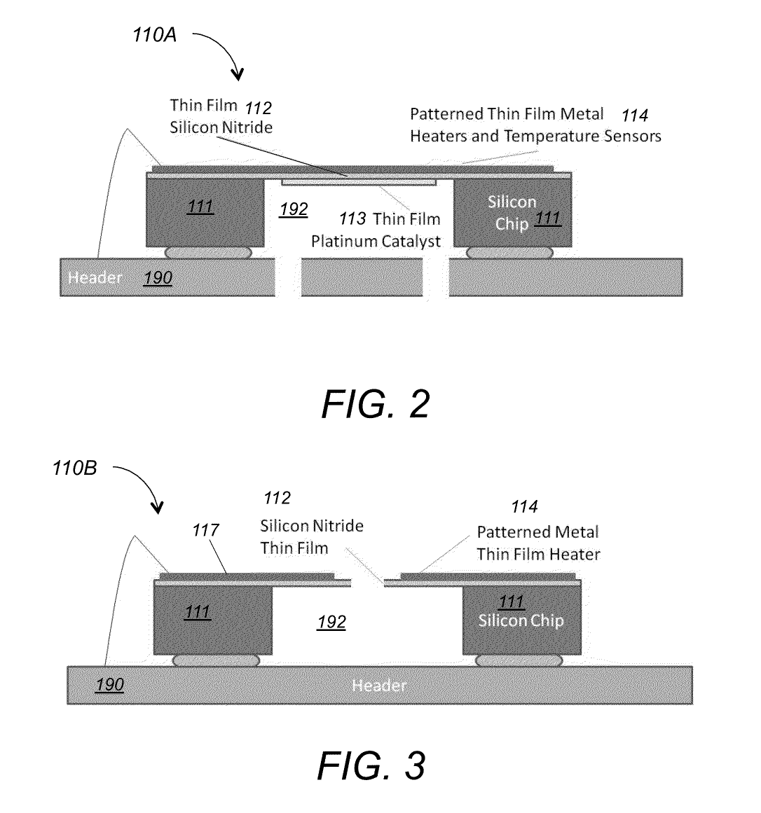

One example of an experiment chip is a catalytic micro-reactor experiment chip 110A, shown in FIG. 2. This silicon chip 111 has a thin membrane 112 suspended above a channel 192. The thin membrane 112 has thin film metal heaters and temperature sensors 114 placed on the outside of the channel and a catalytic thin film 113 placed on the inside of the channel 192. When reactive gases are flown through the channel 192, the temperature of the membrane 112 and the catalyst 113 can be changed using the thin film heaters and monitored using the thin film temperature sensors 114. As the reaction takes place on the catalyst 113, the heat of the reaction changes the temperature profile across and up and down the membrane 112. The composition of the exiting stream can be monitored using analytical tools included within the console 130 of the test station 100. This experiment chip 110A can be used to perform experiments illustrating important concepts of heat transport, fluid flow, reaction thermodynamics, catalytic reactions, and reactor design, among others.

Another example of an experiment chip is a stress/strain beams and cantilevers experiment chip 110B, shown in FIG. 3. This silicon chip 111 includes fully released thin film cantilevers and beams 117 supported within a rigid silicon frame. The cantilevers and beams include two layers with different coefficients of thermal expansion. In one example of this experiment one of the layers is silicon nitride 112 and the other layer is platinum metal 114 with a titanium adhesion layer. The metal 114 is patterned in the form of a resistive heater. As voltage is applied to the heater the two materials making up the beams and cantilevers expand at different rates, causing a stress differential within the structures. The stress in turn causes the beams to buckle and the cantilevers to curl. This chip can be used to perform experiments illustrating important concepts about beams and cantilevers, stress/force balances, and coefficient of thermal expansion, among others.

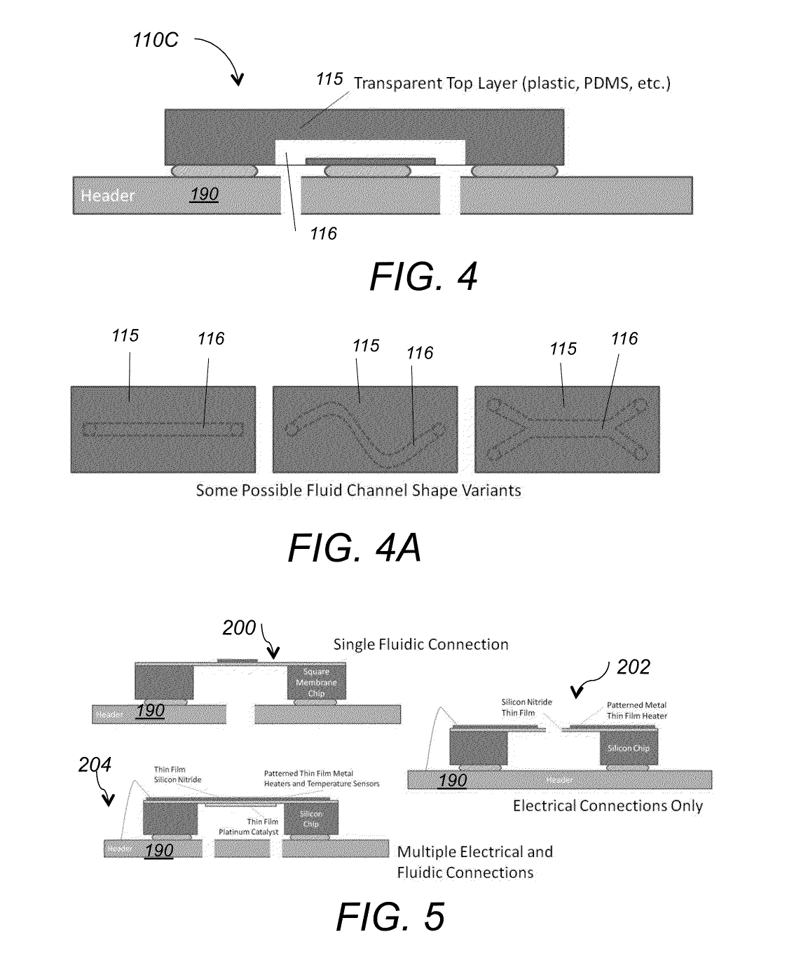

Another example of an experiment chip is a pressure drop in channels experiment chip 110C, shown in FIG. 4. This plastic chip 115 contains several embedded channels 116 of varying geometries, shown in FIG. 4A. A liquid is pumped through the channel 116 at various flow rates and the pressure drop is measured across the channel. Different channel geometries result in different pressure drops. Fluids with different viscosities can be pumped through the chip, also resulting in different pressure drops for similar flow rates. This chip can be used to perform experiments illustrating concepts of pressure driven fluid flow, viscosity, and pressure drop in channels, among others.

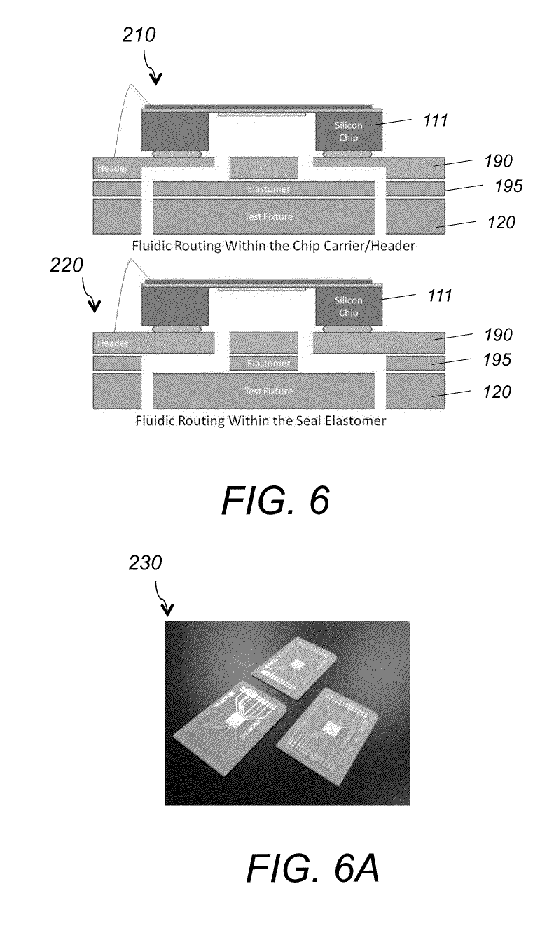

The experiment chips 110 are packaged such that they can all be plugged into a test fixture 120, which in turn serves as the interface to the console 130 containing the system hardware and electronics. The packaging involves attaching the experiment chip to a substrate or a carrier 190. In one example the chips are attached to a circuit board carrier using epoxy, or solder, among others. In another example, the electric connections on the chip are wire-bonded to electric connections on the circuit board, shown in FIG. 6A. The chip packaging allows chips with different electronic connection pad layouts to be connected to a fixed pin layout within the test fixture.

FIG. 5 depicts various experiment chip-packaging examples. The experiment chips are attached to much larger carrier or header boards 190 for ease of handling and for electrical connection routing. Carrier boards are customized for each experiment chip with appropriate through holes or channels for fluidic connections only 200, or conductive metal line to route signals from the each chip to a fixed pin layout for connecting to the console 202, or both 204.

FIG. 6 depicts various fluidic routing examples. Two possible options for connecting appropriate fluidic ports on the chip to the appropriate ports on the test fixture are: by machining channels directly into the header (210) or by machining channels into the elastomer layer (220). In the embodiment 210, the circuit board 190 also serves to complete and enclose fluidic channels within the chip 111. The circuit board may have holes to allow for fluidic connections between the chip and the gas and liquid ports on the test fixture. In the embodiment 220, the chip carrier 190 also has channels built into it to allow for connecting the chip fluidic connections to the test fixture 120 fluidic ports. In another embodiment the packaging also includes an additional layer 195 which completes the fluidic routing and allows for fluidic sealing between the chip carrier and the test fixture . The additional layer 195 can be an elastomer with machined or stamped holes and channels. The packaging is custom designed for each experiment chip to allow for mating of various experiment chip electrical and fluidic layouts with the fixed electrical pins and fluidic ports of the test fixture.

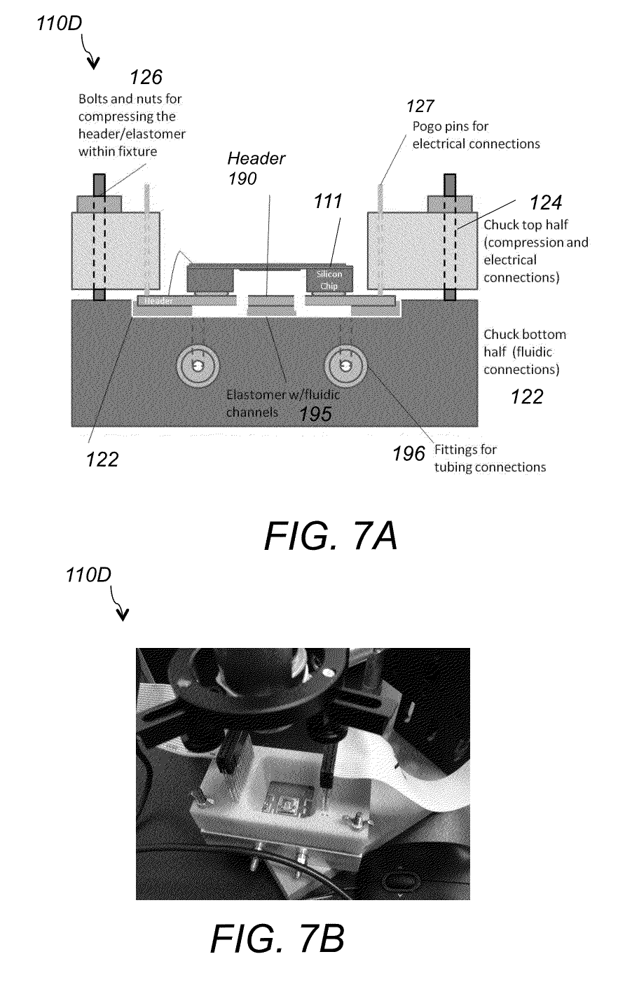

Referring to FIG. 7A, and FIG. 7B, a test fixture 120 includes a bottom half 122 for fluidic connections and a top half 124 for electrical connections. The packaged chip 111 and elastomer 195 are compressed in between the two fixture halves using, for example, bolts and nuts 126 to tighten in place. The test fixture 120 serves as the interface between the experiment chips 111 and the hardware and electronics necessary to carry out the experiments. As described above the chip packaging, potentially including the carrier board and an elastomeric sealing layer can be placed within the test fixture. The test fixture has a movable part 124 which can be removed or moved aside to allow placement of the chip/package within the fixture. Once the chip/package is placed within the test fixture, the movable part 124 is added back in and used to compress the chip/package within the test fixture. The compression is used to accomplish fluidic sealing between the test fixture and the packaged chip. The elastomeric layer of the package compresses to form seals between the elastomer and the test fixture as well as possibly the elastomer and the rest of the chip package. The fixture contains fluidic channels which connect to conventional scale fluidic fittings such as Swagelock, or QuickConnect, among others. These conventional fluidic fittings along with flexible tubing are used to connect the test fixture, and by extension, the packaged chip, to the fluidic components of the MicroLab console 130, such as pressure driven liquid pumps, gas mass flow controllers, or pressure regulators. The critical aspect of the fluidic seals through compression between the packaged chip and the test fixture is that it enables fluidic sealing during the experiment but then also enables rapid exchange to other packaged experiment chips with renewed sealing for a potentially different fluidic configuration.

The test fixture 120 also enables electrical connections between the packaged chip 111 and the MicroLab console 130. In one embodiment the top component 124 of the test fixture which compresses the packaged chip also contains electrical pogo pins 127 which make electrical contact to the electrical pads on the chip package. The pogo pins 127 can then be connected through press-on connectors and ribbon or other cable to the MicroLab console. Other forms of spring-loaded type contacts could be used instead of pogo pins. In another embodiment, the test fixture allows for access to the chip package for edge-card or other similar type of connectors, such that the electrical connections are not an integral part of the fixture, but rather a way to reversibly and quickly attach cables directly to the chip package. In another embodiment, the chip carrier has flexible connectors attached to it which in turn can be plugged into receptors in the fixture.

Another component of the test fixture is a visualization tool 180. It is important for the educational experience that students be able to visualize in real time the experiment chips and the changes they undergo. In one embodiment of the invention, the visualization tool is a CCD camera/microscope 180, attached to the test fixture 120. The attachment of the microscope 180 allows for access to the test fixture for changing out the packaged experiment chips. The visualization component may be attached such that it can be lowered or raised in and out of position on a post. In another embodiment, the visualization component is placed on a swing arm.

The visualization component may also be mounted using x-y-z translators such that it can be moved around to focus on different areas of the chip package at higher levels of magnification. A z-axis translator equipped with a micrometer is used to measure relative position of various on chip components by adjusting the focus plane of the microscope. In addition, the microscope is calibrated to allow for x-y plane measurements as well.

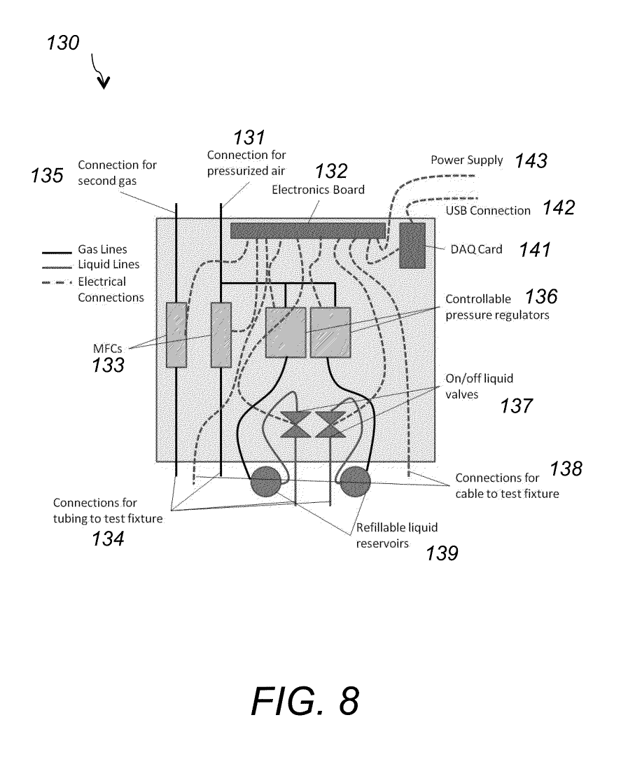

The experimental console 130 contains all the hardware and electronics necessary for conducting various on chip experiments and for data acquisition and communication with the software controlling the system on an attached computer. Referring to FIG. 8, a MicroLab console 130 includes all the hardware and electronics necessary to perform on chip experiments, including mass flow controllers for gases 133, pressure sensors, pressure regulators 136, connectors for pressurized gasses 131, connectors for gasses 135, connectors for tubings to test fixture 134, pressure driven liquid pumps, reservoirs and valves for liquid pumping 139, on/off liquid valves 137, electronics for signal conditioning 132, supplying power 143, and controlling the hardware and the experiment chip 142, and a data acquisition card (DAQ) card 141 for communication with the laptop 140, among others. The fluidic control components may include a single unit readily available on the market, such as for example the gas mass flow controllers, or they may include a number of components assembled together to achieve the desired functionality, such as for example the pressure driven fluid pumps, which consists of pressure regulators, fluid reservoirs, valves, and pressure sensors. All of these components have the applicable power supplied to them, as well as connections for control and data acquisition. The electronics required to operate the fluidic hardware can either be purchased on the market or custom built using multiple components, or PCB boards.

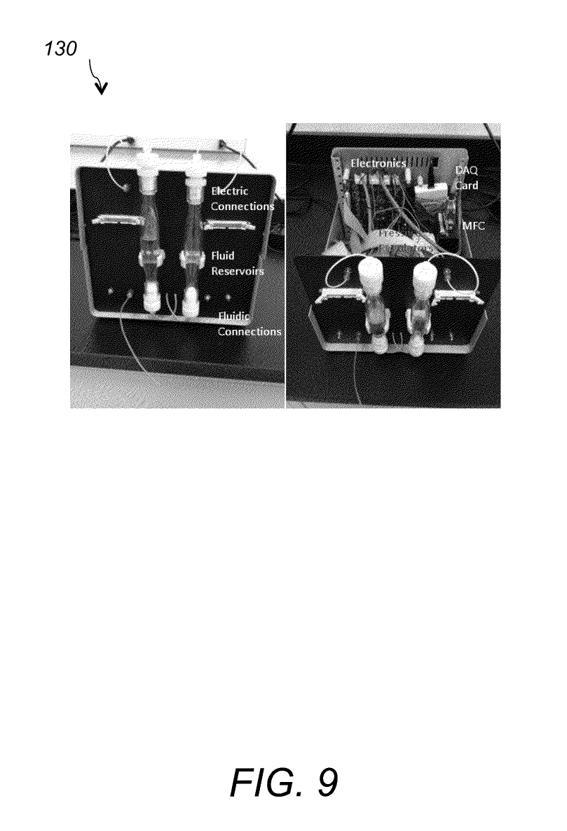

An example of a console 130 with all of the hardware and electronics necessary to conduct the on-chip experiments, is shown in FIG. 9. The console is connected electronically to the test fixture using standard electrical connections such as ribbon cables. The console is fluidically connected to the test fixture using flexible tubing and reusable fluidic connections such as Swagelock. The console has multiple fluidic ports that can be connected to the test fixture in a variety of configurations. In one example, the console has two gas ports connected to gas mass flow controllers inside the console and two ports connected to pressure driven liquid pumps. Depending on the experiment chip inserted into the console, the user must make sure that the fluidic connections between the test fixture and the console are configured appropriately. For example, an experiment chip reacting two gas streams needs to have fluidic connections between the two gas ports on the console and the appropriate two ports on the test fixture. The console also has a power cable to provide power to the electronics and hardware inside as well as a USB cable for connecting to a computer that operates the system using software described below. Finally, the console also has fluidic ports in the back for supplying pressurized air to operate one of the mass flow controllers and the pressure driven liquid pumps, as well as other gases that would be supplied to the experiment chip via the other mass flow controller.

The gas mass flow controllers (MFCs) 133 are located inside the console with fluidic connections between the MFCs and the gas supply back ports on the console, as well as between the MFC outlets and the ports on the front side of the console that supply the test fixture. The pressure driven liquid pumps consist of pressure regulators, fluid reservoirs, and on/off liquid valves. The pressure regulator inlets are connected to the air supply port on the back of the console, with an optional on/off valve helping to reduce air consumption when the liquid pumps are not in use. The pressure regulator outlets are connected via flexible tubing to the liquid reservoirs. The outlets from the liquid reservoirs are connected to the front panel ports using flexible tubing through the on/off liquid valves. The liquid reservoirs are designed to be refillable through removable caps. When the pump runs out of fluid, the pump can be depressurized, the cap removed, and fluid refilled in the reservoir. The cap is then replaced and the pump can resume normal operation. It is important to allow for this easy and flexible replacement of fluids in the liquid pumps as it enables the use of the liquid pumps for a variety of different experiments, depending on the experiment chips and the type of liquids added to the reservoirs. For example, a liquid diffusion experiment may utilize clear water and water with food coloring in the two liquid pumps, while a fluid dynamics experiment may utilize water in one pump and oil in the other. The MFCs and the pressure driven liquid pumps in the console could be of equal capacity or their ranges maybe staggered to allow for greater flexibility. For example, one MFC may operate over a 100 sccm range and the other over a 10 sccm range. Similarly, the top operating pressures of the pressure driven pumps may be 30 psi and 100 psi respectively.

The fluidic components are supplied with power as well as control signals. The power supplies for the fluidic components can be either purchased off the shelf or custom built. In addition to the fluidic hardware and associated electronics, the console contains the electronics required for performing the on-chip experiments and for data acquisition. Some of the electronics include power supplies, current supplies, and voltage sensors, among others. These components can be bought on the market or custom designed and built using multiple components, or PCB boards. Finally, the data acquisition and control of the experiments may require some signal conditioning and multiplexing between the experiment chip and the DAQ card. In one embodiment of the invention the MicroLab electronics necessary for operating the fluidic components, for performing the on chip experiments and for conditioning and multiplexing of the data acquisition signals are custom designed and built on a single pcb-board. In one embodiment all of the console electronics are co-located on a single customized board with multiple electrical connections to the ribbon cables on the front of the console as well as to the fluidic components. The customized board is also connected to an NI xxx module, which enables communication between the electronics and the computer, enabling remote control of the experiment and data acquisition.

The system software accomplishes multiple functions. First, the software provides a menu driven operating system where the user can select from a wide variety of experiments. Once the experiment is selected the software guides the user through installation of the appropriate experiment chip, and through making the fluidic connections between the console and the test fixture. The software then guides the user through the experiment/demonstration. Finally, the menu driven part of the software can help to guide the user through analysis of collected data as well as provide reference materials that explain in detail the relevant engineering concepts. This menu driven portion of the control software can be written using a number of software packages including HTML editors.

The second part of the system software includes the system control software which communicates with the console and the experiment chips, enables the experiments to be carried out and collects the data in a user friendly tabular format. This experiment control part of the software includes a number of modules which correspond to the experiment chip and type of experiment to be performed. For example, a given experiment chip can be operated in an open ended mode, where the user has control over certain parameters and can affect changes and take measurements. Within this open ended mode there could be further options for safe mode operation, where certain inputs to the chip are limited to prevent chip failure. Part of the experiment may be to blow up or break something on a chip, i.e. to test it to failure, but the operator's ability to get to failure accidently can be limited by the software. The open ended module could be preset with the appropriate controls and readouts to perform the experiment, but another variant may also require the user to select from a number of possible inputs and outputs in order to design their own experiment for a given chip. In another example, an experiment chip has a demonstration mode software module, where the software controls the experiment inputs and performs the experimental sequence in an automated fashion, while recording the data. This mode could be useful for example for faculty using the MicroLab to perform in-class demonstrations. All of the experiment control software modules can be written using either a higher level data acquisition and experiment control software such as Labview or using more basic programming languages such as C++.

Several embodiments of the present invention have been described. Nevertheless, it will be understood that various modifications may be made without departing from the spirit and scope of the invention. Accordingly, other embodiments are within the scope of the following claims.

What is claimed is:

1. A micro-laboratory system for performing chemical, mechanical and electrical experiments comprising:
a set of experiment chips wherein each experiment chip comprises chemical, mechanical, or electrical experiments;
a test system, configured to receive said experiment chips and to perform said chemical, mechanical, or electrical experiments comprised in said experiment chips;
fluidic and electrical interfaces connecting the experiment chips and the test system; and
a computing unit configured to connect and communicate with said test system.

2. The micro-laboratory system of claim 1, wherein the experiment chips comprise Micro-Electro-Mechanical-Systems (MEMS) experiment chips that are micro-fabricated on substrates comprising one of silicon, plastic, glass or ceramic materials.

3. The micro-laboratory system of claim 2, wherein the MEMS experiment chips comprise sensors and actuators.

4. The micro-laboratory system of claim 3, wherein the sensors comprise one of thin film resistive temperature sensors, piezoelectric stress sensors, thermocouple temperature sensors, capacitive sensors, or pressure sensors.

5. The micro-laboratory system of claim 3, wherein the actuators comprise one of thin film resistive heaters, electrodes for electrostatic actuation, or electrodes for electrophoretic flow.

6. The micro-laboratory system of claim 1, wherein the test system comprises a test fixture and a test console and wherein the test fixture is configured to receive the experiment chips and is connected to the test console via the fluidic and electrical interfaces.

7. The micro-laboratory of claim 1, further comprising applications configured to run on said computing unit and to provide instructions for selecting, designing and performing experiments, analyzing experimental results and explaining relevant principles of the experiments.

8. The micro-laboratory system of claim 1, wherein the experiment chips comprise materials to be used in the experiments, and wherein said materials comprise one of catalytic materials to be used in carrying out chemical reactions, chemically active coatings for adsorption or separation experiments, or materials that will undergo phase change upon changing temperature.

9. The micro-laboratory system of claim 1, wherein one of the experiment chips comprises a catalytic micro-reactor experiment chip.

10. The micro-laboratory system of claim 9, wherein the catalytic micro-reactor experiment chip is configured to perform experiments comprising one of heat transport, fluid flow, reaction thermodynamics, catalytic reactions or reactor design experiments.

11. The micro-laboratory system of claim 9, wherein the catalytic micro-reactor experiment chip comprises a thin membrane suspended above a channel and wherein the thin membrane comprises thin film metal heaters and temperature sensors placed on an outside of the channel surface and a catalytic thin film placed on an inside of the channel surface.

12. The micro-laboratory system of claim 11, wherein reactive gases are configured to flow through the channel, the temperature of the membrane and the catalytic thin film is configured to be changed and monitored by using the thin film metal heaters and the temperature sensors, respectively, and composition of exiting gasses is configured to be analyzed using analytical tools comprised within the test system.

13. The micro-laboratory system of claim 1, wherein one of the experiment chips comprises a stress/strain beams and cantilevers experiment chip.

14. The micro-laboratory system of claim 13, wherein the stress/strain beams and cantilevers experiment chip is configured to perform experiments comprising one of beams and cantilevers, stress/force balances, or coefficient of thermal expansion.

15. The micro-laboratory system of claim 13, wherein the stress/strain beams and cantilevers experiment chip comprises two-layer beams and cantilevers, and wherein each two-layer beam and cantilever comprises two layers of thin films being superimposed on each other and suspended from a silicon frame, and wherein the two layers of thin films comprise different coefficients of thermal expansion.

16. The micro-laboratory system of claim 15, wherein the two-layer beams and cantilevers comprise a layer of silicon nitride and a layer of platinum metal.

17. The micro-laboratory system of claim 15, wherein one of the two layers of thin films comprises a patterned metal layer configured to function as a resistive heater, and wherein applying voltage to the patterned metal layer heats the two-layer beams and cantilevers and causes the two layers of thin films to expand at different rates and to move relative to each other.

18. The micro-laboratory system of claim 1, wherein one of the experiment chips comprises a fluidic experiment chip.

19. The micro-laboratory system of claim 18, wherein the fluidic experiment chip comprises a clear plastic chip having a channel formed therein.

20. The micro-laboratory system of claim 19, wherein the micro-laboratory system further comprises a pump and a pressure gauge, and wherein the pump is configured to pump a liquid through the channel at selected flow rates and wherein the pressure gauge is configured to measure pressure drop across the channel.

21. The micro-laboratory system of claim 18, wherein the channel comprises one of straight tube-shaped geometry, s-tube-shaped geometry, or multi-tube-shaped geometry.

22. The micro-laboratory system of claim 6, wherein the experiment chips are mounted onto a carrier substrate and wherein the carrier substrate with the mounted experiment chips are configured to be inserted into the test fixture.

23. The micro-laboratory system of claim 22, further comprising an additional layer inserted between the carrier substrate and the test fixture, and wherein the additional layer comprises openings and channels configured to complete fluidic routing, while providing fluidic sealing between the carrier substrate and the test fixture.

24. The micro-laboratory system of claim 22, wherein the carrier substrate comprises openings and channels configured to provide fluidic connections.

25. The micro-laboratory system of claim 22, wherein the carrier substrate further comprises conductive metallic lines configured to provide electrical connections between the substrate mounted experiment chips and the test console.

26. The micro-laboratory system of claim 22, wherein the test fixture comprises a bottom portion and a top portion and wherein the bottom portion comprises fluidic connections and wherein the top portion comprises electrical connections between the experiment chips and the test console.

27. The micro-laboratory system of claim 26, wherein the carrier substrate with the mounted experiment chips are configured to be compressed between the top and bottom portions of the test fixture.

28. The micro-laboratory system of claim 1, further comprising a visualization tool.

29. The micro-laboratory system of claim 28, wherein the visualization tool comprises a CCD camera and microscope configured to be attached to the test system.

30. The micro-laboratory system of claim 6, wherein the test console comprises hardware components and electronic components used for performing the chemical, mechanical, or electrical experiments comprised in said experiment chips.

31. The micro-laboratory system of claim 30, wherein the hardware components comprise one of mass flow controllers for gases, pressure regulators, reservoirs, valves for liquid pumping, pressure driven liquid pumps, or pressure sensors.

32. The micro-laboratory system of claim 30, wherein the electronic components comprise one of electronic components for signal conditioning, supplying power, and controlling the hardware components and the experiment chips, or a data acquisition card.

33. The micro-laboratory system of claim 1, wherein the experiment chips comprises 3-D printed chips.
